(19) United States
(12) Patent Application Publication
(10) Pub. No.: US 2018/0285333 A1
(43) Pub. Date: Oct. 4, 2018

(54) SYSTEM AND METHOD FOR THREE DIMENSIONAL AND GEOSPATIAL REPRESENTATION AND MANIPULATION OF ELECTRONIC DOCUMENTS

(71) Applicant: Dirk Jan RODENBURG, Sydenham (CA)

(72) Inventor: Dirk Jan RODENBURG, Sydenham (CA)

(21) Appl. No.: 15/943,839

(22) Filed: Apr. 3, 2018

Related U.S. Application Data
(60) Provisional application No. 62/481,072, filed on Apr. 3, 2017.

(51) Int. Cl. G06F 17/22; G06F 17/30; G06T 19/00; G06T 17/00

(52) U.S. Cl. CPC G06F 17/2288; G06T 17/005; G06T 19/003; G06F 17/3023

(57) ABSTRACT

A method is disclosed for 3-dimensional and geospatial representation and analysis of at least a portion of an electronic document. The method comprises selecting an electronic document. The electronic document is then ingested. The electronic document is then displayed 3-dimensionally and geospatially on a computer display using one or more geospatial objects. A portion of an electronic document is then isolated and shown in one or more geospatial objects.

### FIELD OF THE INVENTION

The invention herein is directed to systems and methods for 3-dimensional and geospatial representation and manipulation of data and more particularly to 3-dimensional and geospatial representation and manipulation of electronic documents.

### BACKGROUND

Existing methods of viewing document and code versioning and document characteristics/comments are in-line oriented, making it challenging for both authors and viewers to simultaneously understand what has been changed, when it was changed and what the resulting differences are.

This problem becomes increasingly more challenging when multiple versions with multiple authors are involved. Systems using in-line methods of version visualization such as text strikeout and replacement, even when changes are colour coded, are notoriously difficult to make sense of when the number of authors and versions reaches more than three or four. The “track-changes” function in Microsoft Word is a good example of a mechanism that is widely used, but highly problematic from a usability standpoint.

Some code versioning systems have attempted to use alternative presentation techniques such as visually displaying code ‘branches’. Tree and leaf metaphors are also used, but become unwieldy and very difficult to understand and track when the number of branches and leaves becomes larger. This problem is exacerbated when a viewer would like to compare versions across widely divergent branches.

In sum, there is no method that enables authors and viewers to simply and easily get an integrated, visual view of how a document or piece of code has evolved over time, especially when that evolution is complex and multifaceted. Document representations are simply too cumbersome, too challenging and too limited to provide effective views of complex versioning data.

There thus remains a need for 3-dimensional and geospatial representation and manipulation of electronic documents.

### SUMMARY OF THE INVENTION

There is a method for geospatial representation and analysis of at least a portion of an electronic document having a version history, the method comprising: selecting at least one electronic document; ingesting the electronic document; displaying the electronic document 3-dimensionally and geospatially on a computer display using one or more geospatial objects; facilitating selection of a portion of an electronic document having a version history; isolating the portion; and showing the version history in one or more geospatial objects.

The showing may comprise showing each version of the portion in a separate 3-dimensional and geospatial object or showing each version in a separate partition of a geospatial object.

There is also a method for 3-dimensional and geospatial representation and use of electronic documents, the method comprising: ingesting a set of electronic documents comprising one or more electronic documents; displaying at least one electronic document of the set of electronic documents 3-dimensionally and geospatially on a computer display.

The ingesting may comprise parsing each electronic document into one or more elements of one or more element types and associating each element type with a 3-dimensional and geospatial object type.

The method may further comprise facilitating manipulation of the 3-dimensional and geospatial objects based on the characteristics of the geospatial object type and the element.

The displaying may comprise showing the 3-dimensional and geospatial objects for each element according to the characteristics of the geospatial object type and the element.

There is also a system for geospatial display and analysis of an electronic document, the system comprising: at least one input device in communication with at least one computer and at least one display, wherein the at least one computing device is capable of storing, modifying, outputting, and retrieving information in communication with the at least one input device and the at least one display; and computer readable instructions installed and capable of running on the at least one computing device, configured to: enable selection of an electronic document for geospatial display and analysis; generate a geospatial display of the electronic document; and output the geospatial display of the electronic document to the at least one display.

The computer readable instructions may be further configured to ingest the electronic document.

The ingesting may further comprise parsing the electronic document into one or more elements of one or more element types and associating each element type with a 3-dimensional and geospatial object type.

The ingesting may further comprise assigning each of the one or more elements into an object of the associated 3-dimensional and geospatial object type to create a set of 3-dimensional and geospatial objects comprising one or more 3-dimensional and geospatial object types and one or more 3-dimensional and geospatial objects of each of such 3-dimensional and geospatial object types.

Each 3-dimensional and geospatial object may have an object level and the set of 3-dimensional and geospatial objects may be organized hierarchically according to object level.

The geospatial display may be organized according to object level.

The computer readable instructions may be further configured to enable manipulation of the geospatial display.

The enabling manipulation may comprise allowing an action for a selected 3-dimensional and geospatial object and observing a characteristic of the selected 3-dimensional and geospatial object.

The at least one computing device and the at least one display may be an augmented reality device.

The computer readable instructions may be accessed via a host application.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1-3 are prior art examples of textual representations of electronic documents having versioning and document characteristics;

FIGS. 5-8 are 3-dimensional and geospatial representations of various data, using known techniques of geospatial representation;

FIG. 9 is an example of 3-dimensional and geospatial representation and manipulation of an electronic document according to an aspect of the present invention; and

FIG. 10 is an example of a method for ingestion and pre-processing of an electronic document for 3-dimensional and geospatial representation and manipulation;

FIG. 11 is an example of a method for 3-dimensional and geospatial representation and manipulation of an electronic document according to an aspect of the present invention; and

FIG. 12 illustrates an exemplary computing device which may be used to implement a hardware element of the present invention.

### DETAILED DESCRIPTION OF THE PREFERRED EMBODIMENTS

As used herein, the following terms have the following meanings:

Element: a feature, portion, or building block of an electronic document. For example, an element may be a range of line numbers, section headers, page breaks, functionality demarcations (for example function calls), and the like.

3-Dimensional and Geospatial objects: one or more visual objects or object types that can be displayed on a display and can represent one or more elements and have one or more associated 3-dimensional and geospatial object actions.

3-Dimensional and Geospatial target: the item that is to be interpreted via 3-dimensional and geospatial techniques described herein. Exemplary 3-dimensional and geospatial targets include a set of electronic documents or an electronic document.

Set of electronic documents: one or more electronic documents, which may be text-based electronic documents (ie predominantly having text) that may somehow be related, such as being similar but for changes/amendments, being in the same folder or folder structure, being part of a collection of related materials, and the like. This may also be referred to as a 3-dimensional and geospatial target and may also be called a corpus.

Electronic documents: one or more electronic files such as those largely made up of text, such as Word™ documents or source code documents that may have different versions, track changes, and other document characteristics, audio/video such as MP4/MOV/AVI files, rendered and/or computationally derived 3D models and graphics such as CAD/JPG/OBJ files and all other media types that may include versioning and version lineage. These may be referred to herein as documents or electronic documents.

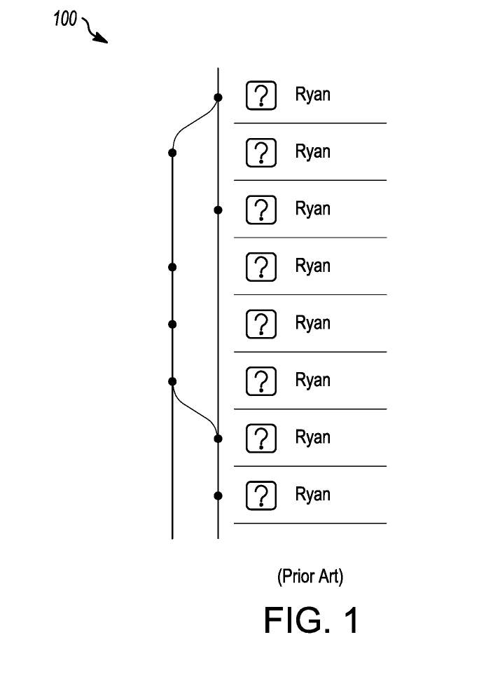

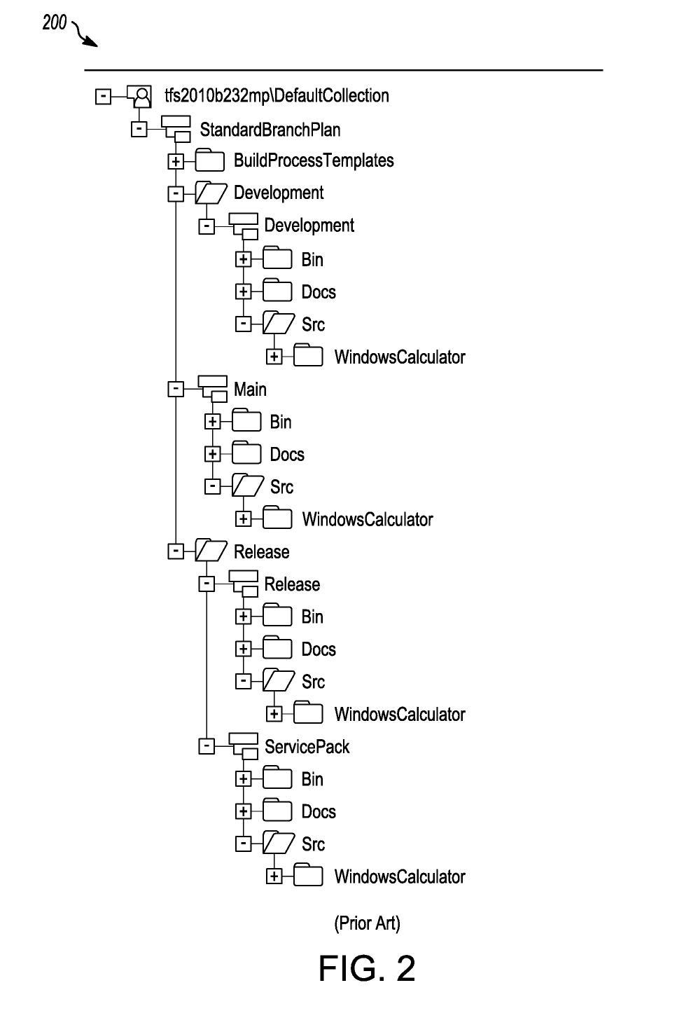

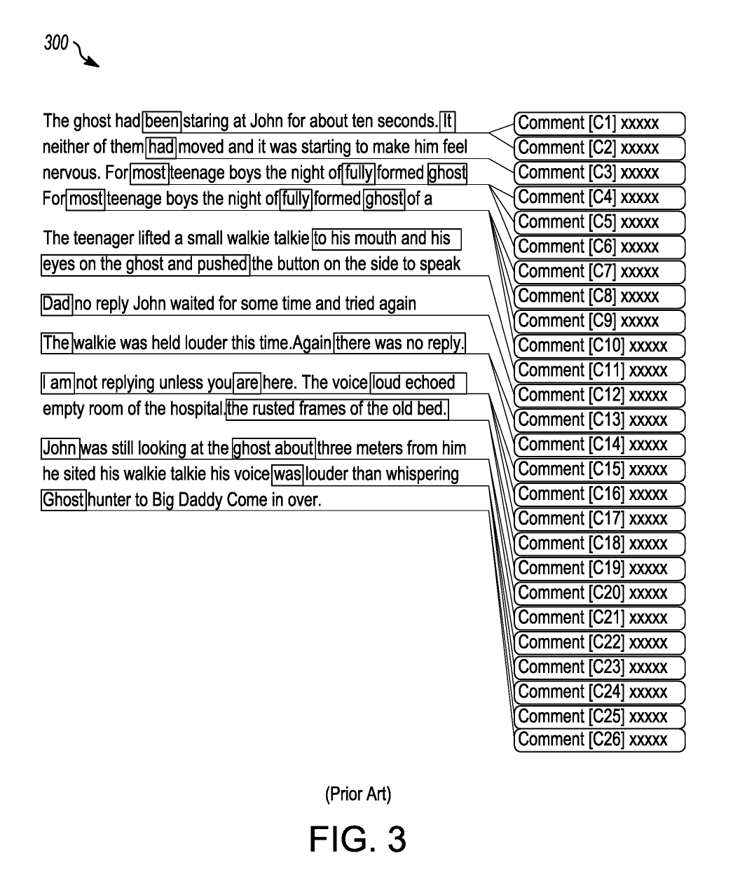

FIGS. 1-3 show prior art approaches to representing electronic documents. These are substantially as described herein and present prior art approaches to representing electronic documents such as line view 100, folder view 200, track changes view 300.

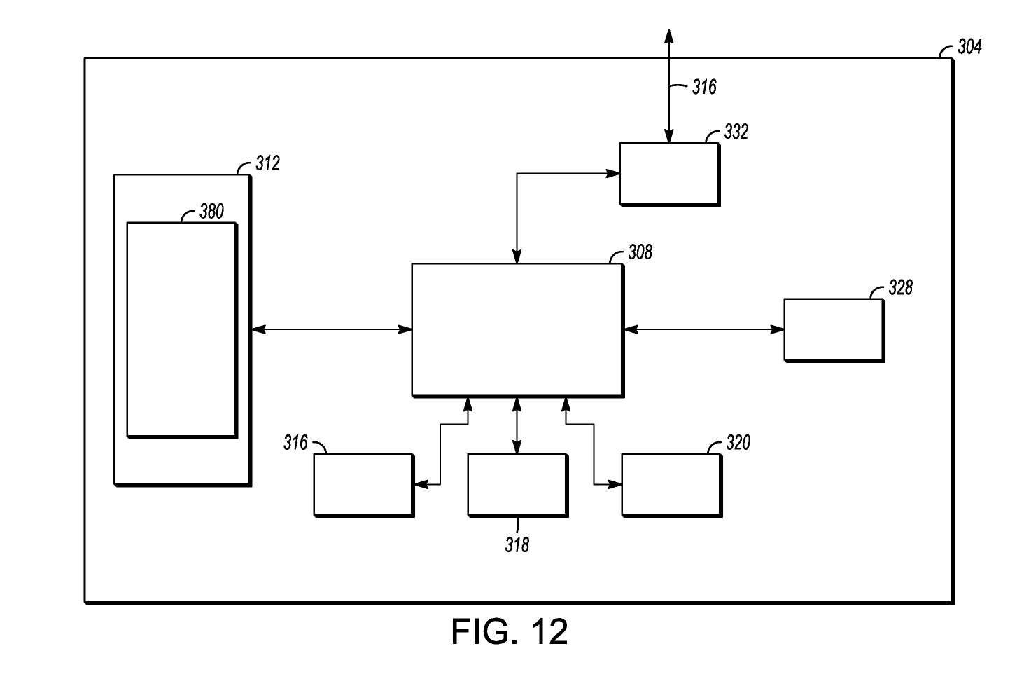

The systems and methods described herein may be implemented on or by one or more computer systems having one or more computing devices 304, substantially as known in the art and as illustrated in FIG. 12. Such computer systems may include at least one main processor 308 that controls the overall operation of the computing device 304. The computing device is interconnected with a non-transitory computer readable storage medium such as a memory 312. Memory 312 can be any desired combination of volatile (ie RAM) and non-volatile (ie ROM), including Electrically Erasable Programmable Read Only Memory (“EEPROM”), flash memory, magnetic computer storage device, or optical disc memory.

As shown in FIG. 12, computing device 304 also includes one or more input devices interconnected with a main processor 308. Such input devices are configured to receive input and provide data representative of such input to processor 308. Input devices can include, for example, a keypad 316 and a pointing device 318. Thus, keypad 316 can receive input in the form of the depression of one or more keys, and can then provide data representative of such input to processor 308. In variations, a keyboard can be implemented as a soft keyboard relying on a touch screen, for example. A pointing device can be implemented as a computer mouse, track ball, track wheel, touchscreen, and the like. In some examples, such as with an on board computer, a computing device can include additional input devices in the form of one or more additional buttons, light sensors, microphones and the like. Pointing device can receive input in the form of movement, pressure or swipe gestures, and can then provide data representative of such input to processor 308 in the form of, for example, coordinates representing the location of a virtual cursor, the direction and/or velocity of a swipe gesture, and the like.

Computing device further includes one or more output devices. The output devices of computing device include a display 320. Display 320 includes display circuitry controllable by processor for generating interfaces which include representations of data and/or applications maintained in memory 312. The display circuitry can thus include any suitable combination of display buffers, transistors, LCD cells, plasma cells, phosphors, LEDs and the like. When the input devices of computing device include a touch screen input device, the touch screen (not shown) can be integrated with display. The output devices of computing device can also include a speaker 328 interconnected with processor. Additional output devices are also contemplated, such as wearable devices such as for augmented reality (AR), virtual reality (VR), and the like (which may include both a computing device 304 and/or a display 320).

Computing device also includes a communications interface 332 interconnected with a processor 308. Communications interface allows computing device to perform voice and/or data communications via a link 336, which can be wired and/or wireless, and, where appropriate, with or via a network (not shown). The communication interface receives messages from and sends messages through the link 336.

Computing device maintains, in memory 312, one or more files containing a plurality of computer readable instructions and/or data. Typically, files are organized in accordance with a structure and logic referred to as a file system 380. In this illustrative example, file system maintained in memory represents the structure and organization of files accessible by computing device.

Files (both containing the logic to implement aspects of the invention herein and electronic documents and sets thereof) are typically stored in a non-volatile portion of memory 312 such as a solid state disk or a hard drive. In variations, the files can be stored in other portions of memory such as in volatile memory or in a combination of different portions. In yet other variations, some of the files may be stored in memory or storage locations that are external to computing device, such as those maintained at network-based cloud storage. The location of files can also vary based on the operational state of the computing device. For example, files may be maintained in a non-volatile portion of memory when the computing device is turned off. However, at least some of the files may be moved into a volatile portion of memory as the computer device is powered up, or otherwise rendered operational. In variations, files may be moved to volatile memory as the files are accessed by processor. Other combinations of memory portions and operational states for storing files within memory will now occur to a person of skill and are contemplated.

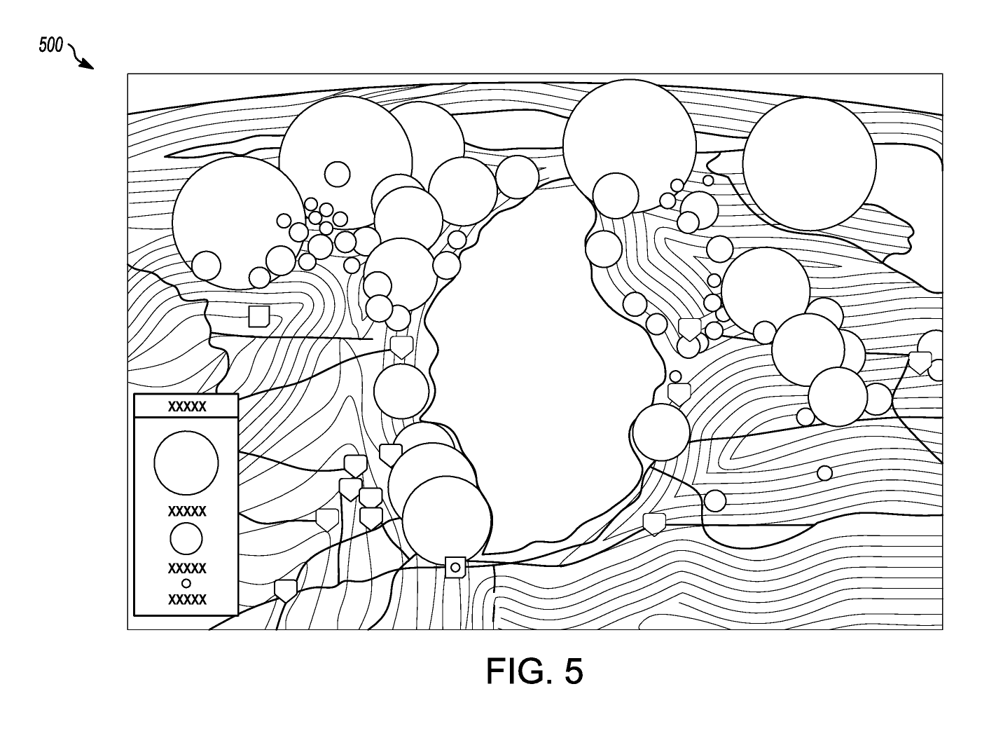

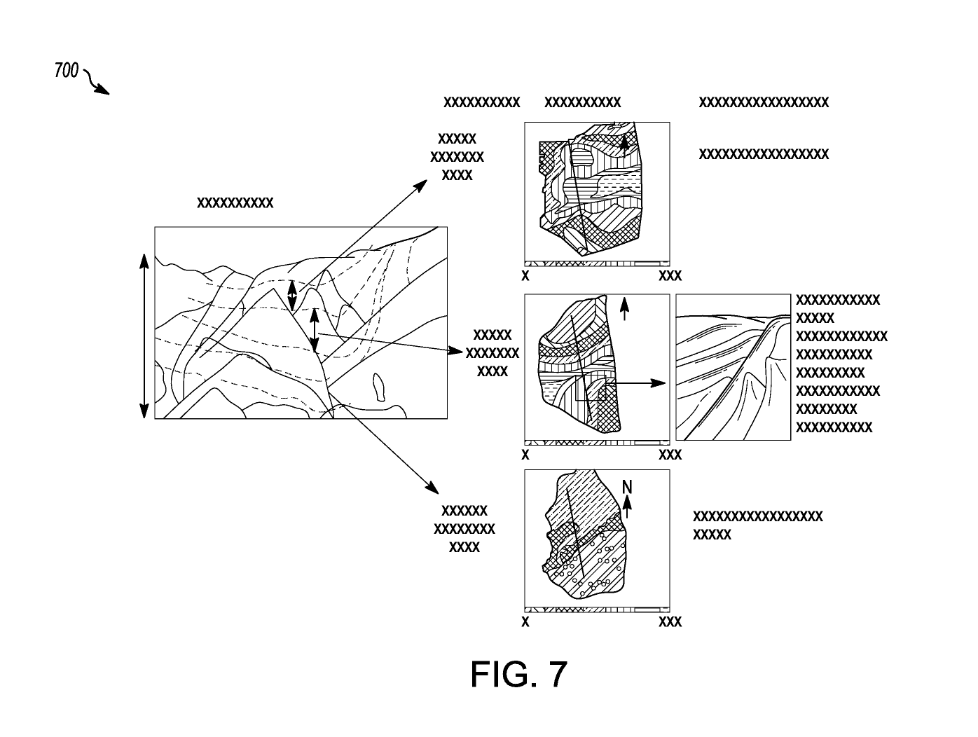

FIGS. 4-8 are 3-dimensional and geospatial representations (on fourth display 400, fifth display 500, sixth display 600, seventh display 700 and eighth display 800) of rich and complex data sets, each figure comprising various 3-dimensional and geospatial objects representing some form of data. These often static, sometimes dynamic, views enable the integrated presentation of complex information within a bounded and easily understood framework. No specialized interpretive skills are required, despite the large number of visual and interpretive affordances these displays offer.

3-Dimensional and Geospatial displays can be as simple as a line based 2D map, or as complicated as a 3D or 4D (with the addition of a dynamic representation of time) topological representation of layered surfaces and substrates, tracing the evolution of a particular layer through time, spatial position, material composites, event and change occurrence and density, pressure and compression/expansion and so on.

3-Dimensional and Geospatial representations, because of their visual orientation—and despite their information densities—are readily interpretable. Viewers can easily determine areas of constancy and change through spatial positioning of 3-dimensional and geospatial objects, layering of 3-dimensional and geospatial objects, colour, texture, thickness, proximity and other aspects or characteristics of 3-dimensional and geospatial objects, and so on.

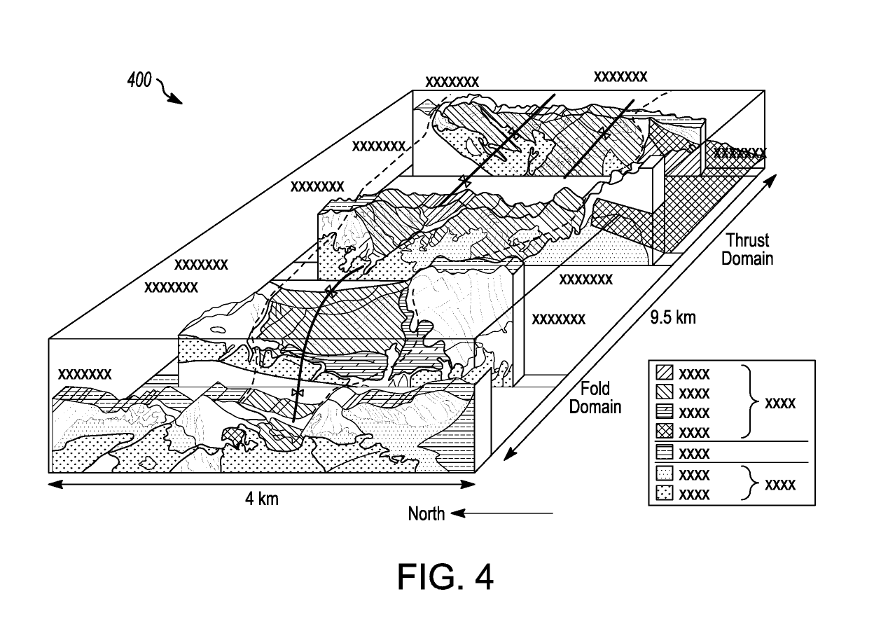

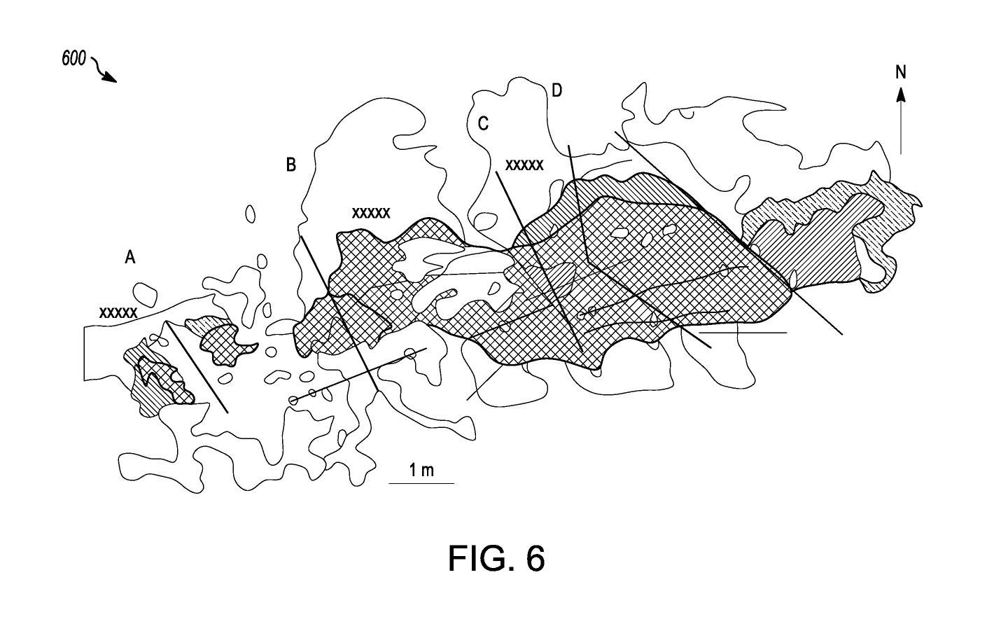

The addition of “informational” features (characteristics) to displays and particular 3-dimensional and geospatial objects (e.g. lines and arrows as in FIG. 7, bubbles as in FIG. 5, surface deformation, colour) also enables an extremely rich representation of process and highlight data, enabling process and movement tracing above and beyond that already encapsulated by the feature/topographical representation.

Different 3-dimensional and geospatial representations provide many different affordances, each emphasizing a different characteristic of the process, form and movement landscape, and all of which provide a readily interpretable, integrated and information rich representation.

Within static images, these include:
1) Ability to display current and past states simultaneously, both as discrete and as linked instances;
2) Ability to show state change as an evolutionary process;
3) Ability to utilize elevation elements such a surface deformation and object height to illustrate arbitrary attributes;
4) Ability to utilize perspective to exploit depth cues for arbitrary attributes; and
5) Ability to utilize layer “stacks” to capture, display and link a large number of states simultaneously

When viewing computer generated 3-dimensional and geospatial images, these features can be responsive to user action to dynamically:
1) Show changes within specific regions (‘zoom in’/‘zoom out’);
2) Show processes leading to state change;
3) Show process change over time;
4) Allow users to include or exclude specific processes for display;
5) Allow users to speed up or slow down specific processes;
6) Allow user to rotate the display to view processes from different angles; and
7) Allow users to incorporate new visualizations such as heat maps and bubble maps.

All of these attributes can be exploited within a versioning system.

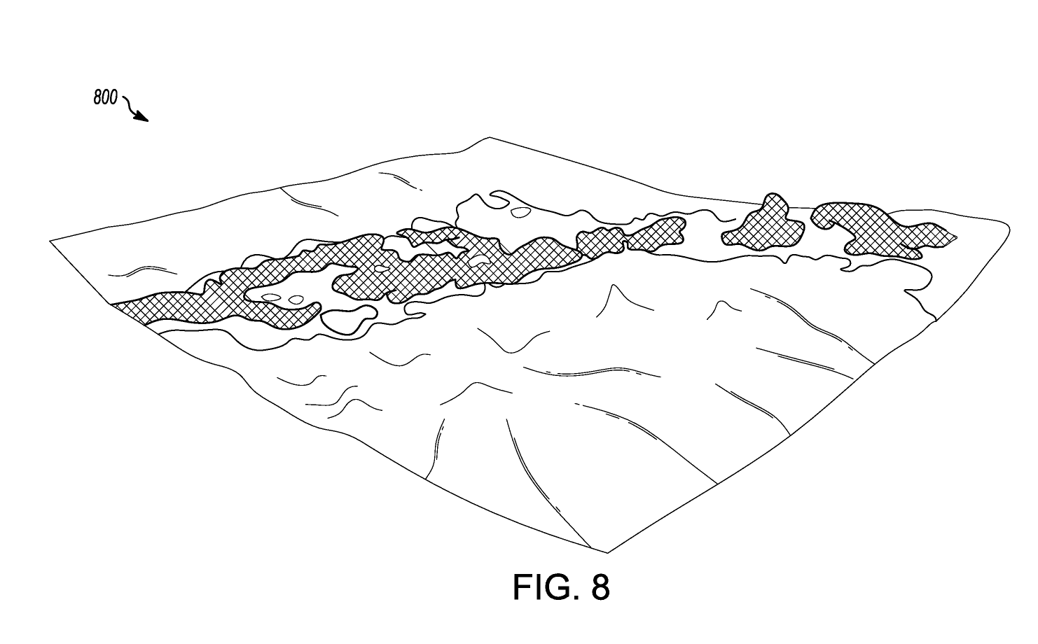

FIG. 9 is an example of 3-dimensional and geospatial representation and manipulation of an electronic document according to an aspect of the present invention. Various techniques, and 3-dimensional and geospatial objects (910/920/930/940/950/960 including various 3-dimensional geospatial object characteristics) are shown, and described, herein. However many arrangements of the 3-dimensional geospatial objects are possible.

Below is a brief description of various 3-dimensional and geospatial object types:
(a) 910: a ruler or timeline object that may be used to show stratification within or between 3-dimensional and geospatial objects (such as 960).
(b) 920: a flip-book object that may be used to show various versions of the same element that are at least partially non-separable (such as different versions of an element that are found in the same document such as via track changes). Flip books may be described as one 3-dimensional and geospatial object having one or more partitions or pages.
(c) 930: an extrusion object that may be used to show various versions of the same element that can be completely separated (such as different version of an element that are found in separate documents).
(d) 940: a drawer element that may be used to show a folder or other collection that houses various files.
(e) 950: a plane object that may be used to show one or more files in a set.
(f) 960: Lines or layers that align with the ruler or timeline object to show ruler, version and or timeline strata.
(g) 970: Extruded object within a version representation that identifies and visually encapsulates an element of the version that is present in multiple versions of the document.

Each 3-dimensional and geospatial object type can have various characteristics (about the 3-dimensional and geospatial object or the element that is saved into an instance of such 3-dimensional and geospatial object type) and various functions related thereto. Characteristics may be viewed by hovering on or selecting the object while functions or actions may be used by selecting menu items, double-clicking, and the like. Exemplary characteristics and functions may include:
(a) Size (characteristic): size of the element.
(b) Author (characteristic): author of the element.
(c) Date (characteristic): when the element was created.
(d) Frequency (characteristic): number of such object type within an electronic document.
(e) Versions (characteristic): number of versions of the element, optionally with pointers or links thereto.
(f) Isolate (function): select the element and remove other information (such as to view “Terms and Conditions” in a legal agreement).
(g) Show Versions (function): for the particular element show all versions thereof.
(h) Zoom in/Zoom out: enlarge or decrease the display of a given element or versions to allow for increased or decreased display of element content and details.
(i) Annotate: provides a mechanism to add a new annotation to any 3-dimensional or geospatial feature of any and all selected documents.
(j) View all Annotations: provides a mechanism to aggregate and view all document and element annotations.
(k) Edit Document/Edit Element: provides a mechanism to enable content of element to be passed to an appropriate editing tool for editing of element where desirable and permissible.

The core object, the electronic document, can be segmented into a range of sections or elements, each of which may have its own version history.

These can be exploded outward into layers to show each version of that section as its own entity, but linked to other versions of that section by virtue of its proximity. This may be seen, for example, at 920.

A number of different metaphors for allowing interaction with these layers can be imagined: slide-in, slide-out (as with 950 and 930), flip-book (as with 920), extrude/intrude (as in 940). Note that the entire document object can be rotated. The addition of a time scale provides a temporal context to each layer (such as 960).

Drawer 940 shows a drawer structure that when opened, can release or allow the user to visually review and access items as displayed 3-dimensionally and geospatially in many forms. Drawer 940 may be used to ‘store’ a set of electronic documents.

An example of these forms includes the pages labelled 950 that are displayed sequentially and may include 910, a ruler or some form of graduated segments that may be on a time scale to show when changes were made to each sheet of 950. Additionally, the ruler 910 may provide a scale of importance or priority to the sheets (950) that can allow the user to easily view and select the document or code they want to from the many sheets (950). The sheets can be compacted down and slid underneath the release (930). The release (930) can visually pack the sheets (950) and the graduated ruler (910) so the user can inspect or view another portion of the documentation or code. The flip-book (920) provides another possible example a way in which the user may contain documentation or code 3-dimensionally or geospatially. The flip-book may be a set of chapters within a whole document, or versions of a portion of an electronic document, among other possibilities. The drawer (940) is a way to compact all documentation or code into a single visual spot or location. The drawer (940) is extended to the open position in FIG. 9 but when closed would show the user that all code and documentation is contained within the drawer (940) without overwhelming the user visually if they have multiple drawers (940) that they need to work between.

The processing and display of a 3-dimensional and geospatially represented electronic document can be either locally or remotely executed by a suitable computer system.

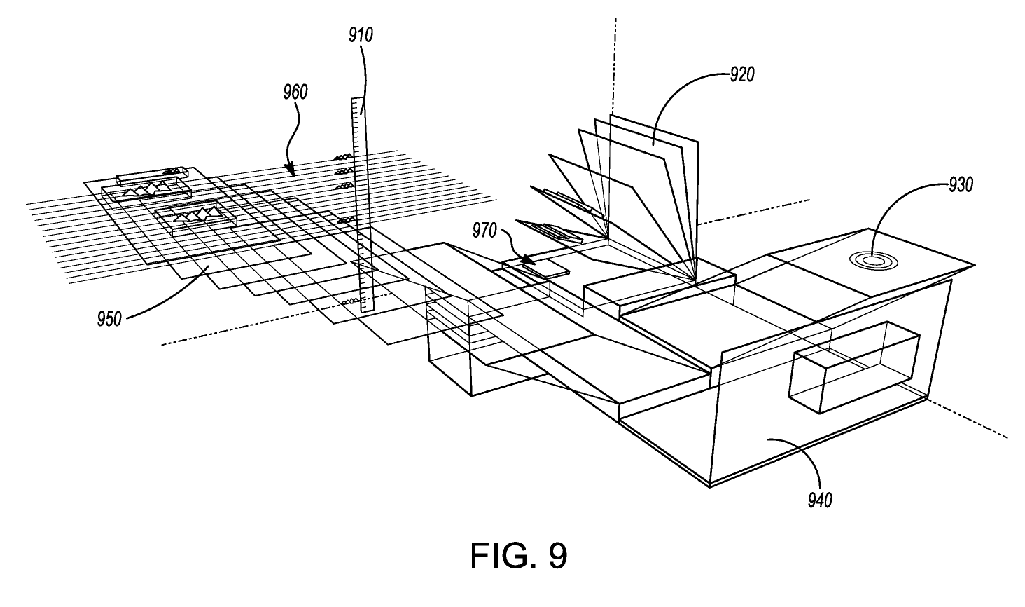

FIG. 10 is an example of a method 1000 for ingestion and pre-processing of an electronic document for geospatial representation and manipulation.

Method 1000 begins at 1002 where one or more 3-dimensional and geospatial targets is selected. This may be, for example a set of electronic documents or one or more particular electronic documents. This may be achieved using gestures, touchscreen, pointers, and the like.

Selecting a 3-dimensional and geospatial target may be done on a computer screen, for example using file explorer software or a native geospatial application that performs the functionality described herein. Alternatively it may be done via one or more applications residing on the computing device (for example a development environment, IDE, that allows selecting a set of computer code files, or Microsoft Word™ that allows selecting text files), or via a terminal connected to a remote system of storage devices and computers via the Internet or other connection type. Selecting may also be done via one or more gestures or the like, used in interacting with AR and/or VR worlds.

After a selection is made, the 3-dimensional and geospatial target may be ingested at 1004. Ingesting in this context may be to parse the 3-dimensional and geospatial target into individual electronic documents and then into various 3-dimensional and geospatial elements. For example, a Word™ document may have a “Title” element, various “section” elements, “page” elements, “paragraph” elements, and/or numbering elements (based on numbering styles chosen within the document). These elements may have a hierarchical structure that follow the various levels of the electronic document (such as Document->Title->Sections->Pages->Paragraphs), which may organize an electronic document. Such a structuring may be linear, nonlinear and may be a tree structure. Each document may have many elements and element types and even a particular line in the Word™ document may be part of various elements. Each of such elements may have characteristics related thereto (number in the set of such elements, the length of the particular element, etc).

Ingesting, at 1004, may include version processing. This may involve obtaining version history from within a particular electronic document or from other electronic documents that are determined to be relatives (ie previous or subsequent versions of the document). As such each element have historical information. The history of each item may be stored within an item or various items may be stored, with interrelationships captured therein.

Parsing may then lead to information being saved with the electronic document (such as inserted as meta-data or a separate file may be saved) at 1006. Processing may include assigning a 3-dimensional and geospatial object or 3-dimensional and geospatial object type to each element, or that may be performed at the time of processing from a locally or remotely stored library of 3-dimensional and geospatial objects through the Internet or other forms of connectivity. Assigning may result in a set of 3-dimensional and geospatial objects comprising one or more 3-dimensional and geospatial object types and one or more 3-dimensional and geospatial objects of each of such 3-dimensional and geospatial object types, which may be considered generating a geospatial display (possibly in combination with further steps, as described herein). Such 3-dimensional and geospatial objects of each of such 3-dimensional and geospatial object types may be organized hierarchically, for example consistently with the hierarchy of the elements of the electronic document (for example an electronic document level may lead to each 3-dimensional and geospatial object having an object level based on such electronic document level). In one example a geospatial display has a hierarchy of a flipbook 920 for a file, with each page being a version. Then each page can become a flipbook of versions or. Then each page of versions can become a flipbook 920 of sections, with one or more extruded objects. If multiple electronic documents are selected and are related to the initial document then they may be shown in a plane object 950, where each plane object can be pulled out to be viewed as a flipbook 920.

Assigning may include determining what actions are required for any given element within the electronic document, including colour, texture, size, 3-dimensional spatial position and orientation, connections to other elements, extrusion level, layer position, and so on. Assignment may also include the type of manipulation that is supported by each 3-dimensional or geospatial element such as rotation, expansion or collapse, zoom in/zoom out, extrusion, layer expansion or collapse and so on. Assigning may also be performed based on known assignment templates where a particular file type, content type, etc is processed according to known rules. For example, source code may always be processed by a source code template and a license agreement may always be processed using a license agreement template. Deviations from templates may be programmed or performed by a user interacting with the system.

At 1008 the 3-dimensional and geospatial target is ready to be used, for example as a geospatial display has been created with the various 3-dimensional and geospatial objects. The geospatial display may be viewed immediately, for example via an initial display (which may be, or may simply wait for a user to decide to interact with it. For example, when a user opens a Word™ document the document may automatically be processed, according to method 1000, in the background. At some future time a user of Word™ may select a function to view the electronic document as a collection of 3-dimensional and geospatial objects, as previously determined via method 1000. Other aspects of the present invention may then be used.

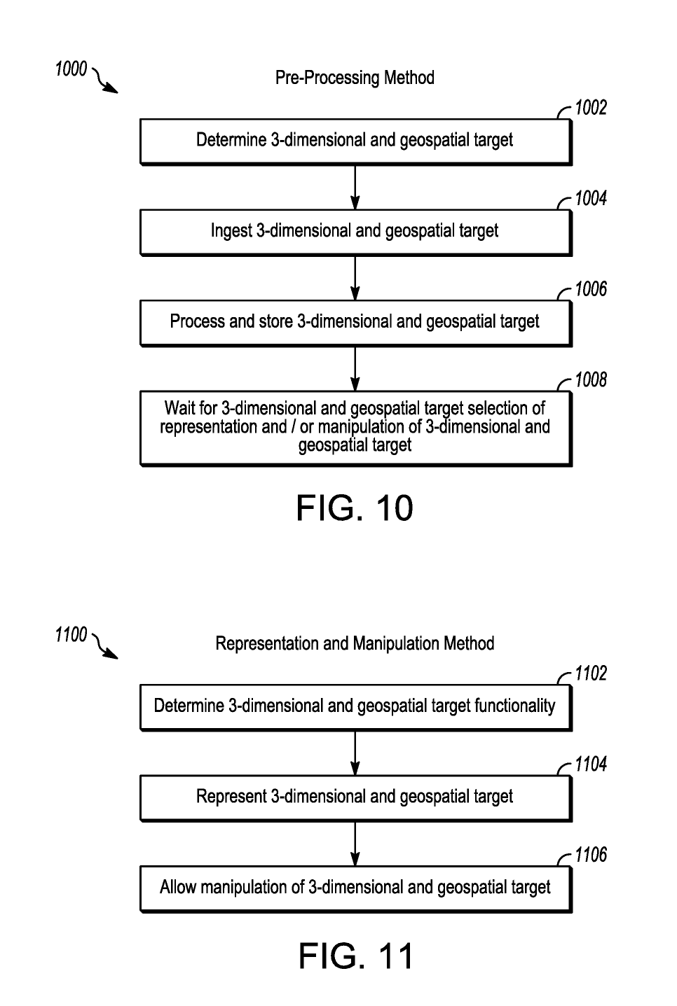

FIG. 11 is an example of a method 1100 for 3-dimensional and geospatial representation and manipulation of an electronic document according to an aspect of the present invention.

Method 1100 begins at 1102 where a 3-dimensional and geospatial target is selected. This may be by similar to as described above with respect to 1002. A user may decide to analyze the history of a license agreement, for example and may click on the agreement, or “open” the drawer (such as 940), flip through the various versions (using 920), and pull out a particular element (like 970, or the whole page from 920).

After making a selection, at 1104 the 3-dimensional and geospatial target is represented, or output, to a display. This may be by placing the various geospatial objects on the display according to their characteristics, as governed by the underlying elements, or simply by displaying the geospatial display.

Once represented, the 3-dimensional and geospatial target, and its various 3-dimensional and geospatial objects, may be manipulated. Manipulation may be governed by the actions possible or allowable for a given 3-dimensional and geospatial object, for example “flipping” for a flipbook, rotating, extruding, and the like. Manipulation may further include one or more ways to observe the 3-dimensional and geospatial object's characteristics (for example hovering over it to see its author, size, and modification date). Manipulation may also be governed by the software application through which the 3-dimensional and geospatial representation is being performed, the elements, or other factors.

### An Example—3DDoc

Overview

The application provides enables the user to perform the following functions on a computer monitor or in virtual 3D through any 3D capable display (e.g. dedicated 3D vision apparatus or augmented reality device):
(a) Search for a document and or specific version in a 3D corpus by utilizing 3-dimensional and geospatial elements such as the ruler/timeline (910), stack display (950), flip-book (920), and drawer (940).
(b) Select a document from a 3D representation of a corpus
(c) Render the document as an object in 3D space with the appropriate geospatial features applied
(d) Easily rotate the document as a 3D object and view from any orientation—if the document contains more than 1 page, these appear as “stacked” pages (950) below the first page and follow the orientation of the 3D document, following the rules of opacity and visibility
(e) View the versions for the selected section as stacked (950)
(f) Dynamically (through hover or other action) “scroll” through the versions, simultaneously seeing thumbnails of the sections (at a user defined size and resolution), its position in the “stack” of changes, and a numerical representation of which version of that section is being currently viewed (i.e. “version 3 of 12”) (950)
(g) Allow all versions to be rendered as individual pagelets across the display, with user defined zoom in/zoom out and continuous contiguous display (920/950)
(h) Hover over any stacked page to view a zoomable thumbnail of the page—default settings in size and resolution for the thumbnail can be determined and saved by the user
(i) Easily select any page for view—pages above that page are shown as stacked pages above the selected page, pages below as stacked pages below the selected page (950), with the position and version of each page oriented against the ruler/timeline (910)
(j) Easily zoom in and zoom out on specific sections of the 3D document
(k) Easily select a default or previously determined and saved orientation to view the 3D document
(l) Easily select or hover over a specific section of the document; this would foreground that section and make other sections less visible (or disappear)
(m) For any selected section, zoom in or out
(n) For any selected section, show visually the depth of the associated versioning for that section (950, 920), including visual representations of versions, comments, etc., against the ruler/timeline (910)
(o) Select a word or phrase in the section, highlight it and show its lineage through all versions simultaneously, whether in stacked or pagelet format (950, 920)
(p) View any selected keyword or phrase as part of a landscape representation of the document—document becomes a flyover map—user can choose to view only those sections of the document containing the selected word or phrase—show navigation bar that allows direct access to each instance
(q) For any selected section, or word or phrase within a section, show its lineage through version history stack—stack is a dynamic display that allows user to ‘scroll’ through versions (950, 920)
(r) For any version or any section, user can switch between 3D and “flat” view.

Use:

Debbie, an intellectual property lawyer, has begun to negotiate a licensing agreement for a patented algorithm that very rapidly detects and maps changes in building structural morphology on behalf of her client, a civil engineering firm. The firm is very eager to get an exclusive licensing arrangement with the developer since it will place their capabilities far ahead of their competition.

Debbie is relatively new to the firm, and relatively new to intellectual property practice. Although she's familiar with the process of negotiation and licensing arrangements in principle, she's unsure about the process as a whole and the range of options available to her as a negotiator.

She first opens the standard licensing agreement used by her firm when negotiating deals such as these. This will serve as her main document template moving forward. She can choose to view the document in a full 3D rendering of all versions, editorial changes and comments as an encapsulated, highly effective method of understanding the evolution of the document and associate rationale for that evolution, for now she's simply interested in the template as a structured container for negotiated license agreement content.

The 3D document viewer shows her the default “flat” view of the document, rendered as a typical “what you see is what you get” (WYSIWYG) sheet of paper, showing the headers, titles, containers and format of license agreement form. However, embedded interactive elements within the form, as well as an accessible but collapsed menu, show her that there is a version history of the document that can be revealed in 3D form if she wishes to access it. In fact, she can choose to render the versioning of a specific section of the document in 3D, a specific container, or the entire document.

She then opens an existing exclusive license agreement that had been already been negotiated by her firm for another client in the 3D document viewer. As with the template, this document opens in the default “flat” view.

However, in this case, Debbie wishes to understand the evolution of the agreement text throughout its version history. In particular, her current focus is the evolution of the “Terms and Conditions” of the license agreement which is, in her view, excessively permissive.

She accesses the collapsed 3D Document menu and switches to “3D” view (such as via a menu option in Microsoft Word™, an example of a host application that may host the computer readable instructions described herein and allow access thereto). This transforms the view to show the document rendered as a 3D object in perspective, hovering in virtual Cartesian space. By default, the most recent version of the license agreement is displayed, and may be displayed hierarchically according to the electronic document levels, and hence hierarchy of the 3-dimensional and geospatial objects (for example a single flipbook 920 with the front page being the most recent version). To view the version history of the Terms and Conditions of the document, she:
(a) Searches for the phrase “Terms and Conditions”—this action re-renders the document, as a modified geospatial display, in the display as a 3 dimensional stack of virtual pages and rapidly “flips” through the pages to show the start point of that section of the document (for example a new flipbook 920 that has all versions as a separate page). If more than a single instance of the search phrase had been returned, each instance of the phase would have been listed with a pointer to its page position within the stacked virtual pages. Debbie would be able to hover over or click on each instance to view the context for the occurrence.
(b) Clicks on the title of the “Terms and Conditions” section of the document, and then within the displayed context menu, clicks the “Isolate” function. This removes all extraneous elements of the document and shows only the “Terms and Conditions” section as a 3 dimensional version stack.
(c) Clicks on a specific term within the “Terms and Conditions” section of the document which immediately rerenders the document as a stack of version changes for that section of the document within the context of the “Terms and Conditions”. All version changes are highlighted by gradations colour and texture to indicate type and scale of change as well as ensure that it is visually simple to segregate the linkages for that section of the document and understand the lineage.
(d) Zooms through the various versions of the selected term within the context of that section of the document. She can smoothly zoom in (from most to least recent version) or zoom out from least to most recent version.
(e) Views all annotations associated with a specific version change.
(f) Selects “View related version changes” which rerenders the document to include the full document version history, showing the version history for the “Terms and Conditions” section as a visually distinct element within the full version history. This is achieved through a combination of the use of texture, colour and transparency.

It will be apparent to one of skill in the art that other configurations, materials etc may be used in any of the foregoing embodiments of the products, methods, and systems of this invention. It will be understood that the specification is illustrative of the present invention and that other embodiments within the spirit and scope of the invention will suggest themselves to those skilled in the art.

What is claimed is:

1. A method for geospatial representation and analysis of at least a portion of an electronic document having a version history, the method comprising:
selecting at least one electronic document;
ingesting the electronic document;
displaying the electronic document 3-dimensionally and geospatially on a computer display using one or more geospatial objects;
facilitating selection of a portion of an electronic document having a version history;
isolating the portion; and
showing the version history in one or more geospatial objects.

2. The method of claim 1 wherein the showing comprises showing each version of the portion in a separate 3-dimensional and geospatial object or showing each version in a separate partition of a geospatial object.

3. A method for 3-dimensional and geospatial representation and use of electronic documents, the method comprising:
ingesting a set of electronic documents comprising one or more electronic documents;
displaying at least one electronic document of the set of electronic documents 3-dimensionally and geospatially on a computer display.

4. The method of claim 3 wherein the ingesting comprises parsing each electronic document into one or more elements of one or more element types and associating each element type with a 3-dimensional and geospatial object type.

5. The method of claim 4 further comprising facilitating manipulation of the 3-dimensional and geospatial objects based on the characteristics of the geospatial object type and the element.

6. The method of claim 4 wherein the displaying comprises showing the 3-dimensional and geospatial objects for each element according to the characteristics of the geospatial object type and the element.

7. A system for geospatial display and analysis of an electronic document, the system comprising:
at least one input device in communication with at least one computer and at least one display, wherein the at least one computing device is capable of storing, modifying, outputting, and retrieving information in communication with the at least one input device and the at least one display; and
computer readable instructions installed and capable of running on the at least one computing device, configured to:
enable selection of an electronic document for geospatial display and analysis;
generate a geospatial display of the electronic document; and
output the geospatial display of the electronic document to the at least one display.

8. The system of claim 7 wherein the computer readable instructions are further configured to ingest the electronic document.

9. The system of claim 8 wherein the ingesting further comprises parsing the electronic document into one or more elements of one or more element types and associating each element type with a 3-dimensional and geospatial object type.

10. The system of claim 9 wherein the ingesting further comprises assigning each of the one or more elements into an object of the associated 3-dimensional and geospatial object type to create a set of 3-dimensional and geospatial objects comprising one or more 3-dimensional and geospatial object types and one or more 3-dimensional and geospatial objects of each of such 3-dimensional and geospatial object types.

11. The system of claim 10 wherein each 3-dimensional and geospatial object has an object level and the set of 3-dimensional and geospatial objects are organized hierarchically according to object level.

12. The system of claim 11 wherein the geospatial display is organized according to object level.

13. The system of claim 7 wherein the computer readable instructions are further configured to enable manipulation of the geospatial display.

14. The system of claim 13 wherein the enabling manipulation comprises allowing an action for a selected 3-dimensional and geospatial object and observing a characteristic of the selected 3-dimensional and geospatial object.

15. The system of claim 7, wherein the at least one computing device and the at least one display are an augmented reality device.

16. The system of claim 7 wherein the computer readable instructions are accessed via a host application.
